(19) United States
(12) Patent Application Publication
(10) Pub. No.: US 2024/0427001 A1
(43) Pub. Date: Dec. 26, 2024

(54) DISTRIBUTED SENSING FOR VELOCITY ESTIMATION

(71) Applicant: QUALCOMM Incorporated, San Diego, CA (US)

(72) Inventors: Preeti KUMARI, San Diego, CA (US); Anantharaman BALASUBRAMANIAN, San Diego, CA (US); Kapil GULATI, Belle Mead, NJ (US); Gabi SARKIS, San Diego, CA (US); Junyi LI, Fairless Hills, PA (US)

(21) Appl. No.: 18/340,674

(22) Filed: Jun. 23, 2023

(51) Int. Cl. G01S 13/58

(52) U.S. Cl. CPC G01S 13/588

(57) ABSTRACT

Various aspects of the present disclosure generally relate to wireless communication. In some aspects, a user equipment (UE) may estimate a velocity of a target object. The UE may output a velocity estimation request. The UE may receive one or more of distributed estimation data or an estimated velocity associated with the target object, the distributed estimation data being collected by one or more anchor nodes and the estimated velocity being based on the distributed estimation data. Numerous other aspects are described.

### FIELD OF THE DISCLOSURE

Aspects of the present disclosure generally relate to wireless communication and to techniques and apparatuses for distributed sensing for velocity estimation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include estimating a velocity of a target object. The method may include outputting a velocity estimation request. The method may include receiving one or more of distributed estimation data or an estimated velocity associated with the target object, the distributed estimation data being collected by one or more anchor nodes and the estimated velocity being based on the distributed estimation data.

Some aspects described herein relate to a method of wireless communication performed by a UE. The method may include performing a monostatic sensing operation on a target object. The method may include outputting a velocity estimation request to each of one or more anchor nodes. The method may include receiving distributed estimation data output by the one or more anchor nodes. The method may include estimating a velocity of the target object based, at least in part, on the distributed estimation data.

Some aspects described herein relate to a method of wireless communication performed by a network node. The method may include receiving a velocity of a target object output by a UE. The method may include receiving a velocity estimation request from the UE. The method may include outputting the velocity estimation request to one or more anchor nodes. The method may include receiving distributed estimation data output by the one or more anchor nodes. The method may include outputting one or more of the distributed estimation data or an estimated velocity associated with the target object, the estimated velocity being based on the distributed estimation data.

Some aspects described herein relate to a UE for wireless communication. The UE may include one or more memories and one or more processors coupled to the one or more memories. The one or more processors may be configured to estimate a velocity of a target object. The one or more processors may be configured to output a velocity estimation request. The one or more processors may be configured to receive one or more of distributed estimation data or an estimated velocity associated with the target object, the distributed estimation data being collected by one or more anchor nodes and the estimated velocity being based on the distributed estimation data.

Some aspects described herein relate to a UE for wireless communication. The UE may include one or more memories and one or more processors coupled to the one or more memories. The one or more processors may be configured to perform a monostatic sensing operation on a target object. The one or more processors may be configured to output a velocity estimation request to each of one or more anchor nodes. The one or more processors may be configured to receive distributed estimation data output by the one or more anchor nodes. The one or more processors may be configured to estimate a velocity of the target object based, at least in part, on the distributed estimation data.

Some aspects described herein relate to a network node for wireless communication. The network node may include one or more memories and one or more processors coupled to the one or more memories. The one or more processors may be configured to receive a velocity of a target object output by a UE. The one or more processors may be configured to receive a velocity estimation request from the UE. The one or more processors may be configured to output the velocity estimation request to one or more anchor nodes. The one or more processors may be configured to receive distributed estimation data output by the one or more anchor nodes. The one or more processors may be configured to output one or more of the distributed estimation data or an estimated velocity associated with the target object, the estimated velocity being based on the distributed estimation data.

Some aspects described herein relate to a non-transitory computer-readable medium that stores a set of instructions for wireless communication by a UE. The set of instructions, when executed by one or more processors of the UE, may cause the UE to estimate a velocity of a target object. The set of instructions, when executed by one or more processors of the UE, may cause the UE to output a velocity estimation request. The set of instructions, when executed by one or more processors of the UE, may cause the UE to receive one or more of distributed estimation data or an estimated velocity associated with the target object, the distributed estimation data being collected by one or more anchor nodes and the estimated velocity being based on the distributed estimation data.

Some aspects described herein relate to a non-transitory computer-readable medium that stores a set of instructions for wireless communication by a UE. The set of instructions, when executed by one or more processors of the UE, may cause the UE to perform a monostatic sensing operation on a target object. The set of instructions, when executed by one or more processors of the UE, may cause the UE to output a velocity estimation request to each of one or more anchor nodes. The set of instructions, when executed by one or more processors of the UE, may cause the UE to receive distributed estimation data output by the one or more anchor nodes. The set of instructions, when executed by one or more processors of the UE, may cause the UE to estimate a velocity of the target object based, at least in part, on the distributed estimation data.

Some aspects described herein relate to a non-transitory computer-readable medium that stores a set of instructions for wireless communication by a network node. The set of instructions, when executed by one or more processors of the network node, may cause the network node to receive a velocity of a target object output by a UE. The set of instructions, when executed by one or more processors of the network node, may cause the network node to receive a velocity estimation request from the UE. The set of instructions, when executed by one or more processors of the network node, may cause the network node to output the velocity estimation request to one or more anchor nodes. The set of instructions, when executed by one or more processors of the network node, may cause the network node to receive distributed estimation data output by the one or more anchor nodes. The set of instructions, when executed by one or more processors of the network node, may cause the network node to output one or more of the distributed estimation data or an estimated velocity associated with the target object, the estimated velocity being based on the distributed estimation data.

Some aspects described herein relate to an apparatus for wireless communication. The apparatus may include means for estimating a velocity of a target object. The apparatus may include means for outputting a velocity estimation request. The apparatus may include means for receiving one or more of distributed estimation data or an estimated velocity associated with the target object, the distributed estimation data being collected by one or more anchor nodes and the estimated velocity being based on the distributed estimation data.

Some aspects described herein relate to an apparatus for wireless communication. The apparatus may include means for performing a monostatic sensing operation on a target object. The apparatus may include means for outputting a velocity estimation request to each of one or more anchor nodes. The apparatus may include means for receiving distributed estimation data output by the one or more anchor nodes. The apparatus may include means for estimating a velocity of the target object based, at least in part, on the distributed estimation data.

Some aspects described herein relate to an apparatus for wireless communication. The apparatus may include means for receiving a velocity of a target object output by a UE. The apparatus may include means for receiving a velocity estimation request from the UE. The apparatus may include means for outputting the velocity estimation request to one or more anchor nodes. The apparatus may include means for receiving distributed estimation data output by the one or more anchor nodes. The apparatus may include means for outputting one or more of the distributed estimation data or an estimated velocity associated with the target object, the estimated velocity being based on the distributed estimation data.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of cooperative and co-design joint communication and radar systems, in accordance with the present disclosure.

FIG. 5 is a diagram illustrating an example of monostatic sensing using a joint communication and radar system, in accordance with the present disclosure.

FIG. 6 is a diagram illustrating an example of distributed sensing using a joint communication and radar system, in accordance with the present disclosure.

FIG. 7 is a diagram illustrating an example associated with distributed sensing for velocity estimation, in accordance with the present disclosure.

FIG. 8 is a diagram illustrating an example associated with distributed sensing for velocity estimation using sidelink, in accordance with the present disclosure.

FIG. 9 is a diagram illustrating an example process performed, for example, by a UE, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Joint communication and radar (JCR) systems enable simultaneous operation of communication and radar functions by sharing hardware and spectral resources. JCR systems incorporate spectrum sharing techniques, adaptive algorithms, cognitive radio concepts, advanced signal processing methodologies, and hardware integration to achieve efficient and reliable performance.

Two implementations of JCR include cooperative JCR and co-design JCR. With cooperative JCR, communication and radar functions operate separately but are configured to cooperate with one another so that the communication and radar functions can exchange information and modify their operational parameters in real time. Cooperative JCR systems, therefore, allow spectrum reuse and provide case of implementation. With co-design JCR, communication and radar functions share hardware components, which allows hardware and spectrum reuse despite necessitating modifications of the transmitter, receiver, or both.

JCR systems can be used to facilitate monostatic sensing for velocity estimation by a user equipment (UE). When used for velocity estimation, the UE transmits a waveform toward one or more target objects, such as nearby vehicles. The UE can estimate the velocity of the target object based on the signals that reflect from the target. A monostatic radar cross-section (RCS) varies with an angle of incidence. At certain angles where the monostatic RCS is very low, the UE may experience poor target detection and estimation performance. Moreover, monostatic sensing is limited to the radial direction relative to the UE and may be impacted by other objects between the UE and target objects. Further, velocity estimation using monostatic sensing can be negatively impacted by small resource availability.

Various aspects relate generally to distributed sensing for velocity estimation. Some aspects more specifically relate to configuring multiple UEs to perform monostatic sensing operations on the same target object and aggregating the data collected by each of the UEs to estimate the velocity of the target object. In some examples, a UE estimates a velocity of a target object; outputs a velocity estimation request; and receives one or more of distributed estimation data or an estimated velocity associated with the target object, the distributed estimation data being collected by one or more anchor nodes and the estimated velocity being based on the distributed estimation data. In some examples, a UE performs a monostatic sensing operation on a target object, outputs a velocity estimation request to each of one or more anchor nodes, receives distributed estimation data output by the one or more anchor nodes, and estimates a velocity of the target object based on the monostatic sensing operation and the distributed estimation data. In some examples, a network node receives a velocity of a target object output by a UE; receives a velocity estimation request from the UE; outputs the velocity estimation request to one or more anchor nodes; receives distributed estimation data output by the one or more anchor nodes; and outputs one or more of the distributed estimation data or an estimated velocity associated with the target object, the estimated velocity being based on the distributed estimation data.

Particular aspects of the subject matter described in this disclosure can be implemented to realize one or more of the following potential advantages. In some examples, by receiving one or more of distributed estimation data or an estimated velocity associated with the target object, the described techniques can be used by the UE to more accurately estimate the velocity of target objects. In some examples, by outputting the velocity estimation request to one or more anchor nodes, the described techniques can be used by the network node to facilitate distributed velocity sensing among multiple UEs.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

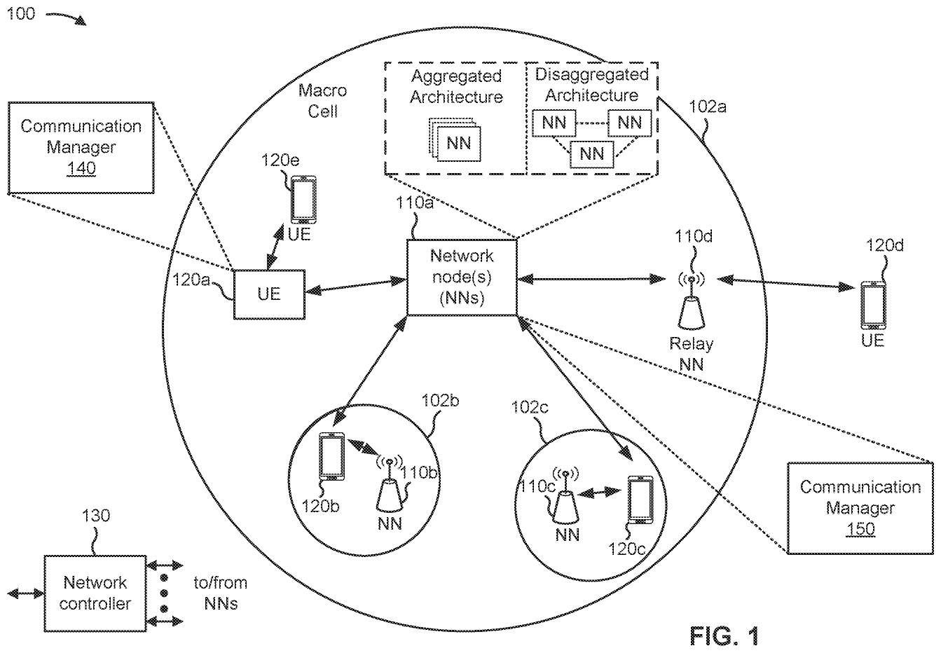

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may estimate a velocity of a target object; output a velocity estimation request; and receive one or more of distributed estimation data or an estimated velocity associated with the target object, the distributed estimation data being collected by one or more anchor nodes and the estimated velocity being based on the distributed estimation data.

In some aspects, the communication manager 140 may perform a monostatic sensing operation on a target object, output a velocity estimation request to each of one or more anchor nodes, receive distributed estimation data output by the one or more anchor nodes, and estimate a velocity of the target object based, at least in part, on the distributed estimation data. Additionally, or alternatively, the communication manager 140 may perform one or more other operations described herein.

In some aspects, the network node 110 may include a communication manager 150. As described in more detail elsewhere herein, the communication manager 150 may receive a velocity of a target object output by a UE; receive a velocity estimation request from the UE; output the velocity estimation request to one or more anchor nodes; receive distributed estimation data output by the one or more anchor nodes; and output one or more of the distributed estimation data or an estimated velocity associated with the target object, the estimated velocity being based on the distributed estimation data. Additionally, or alternatively, the communication manager 150 may perform one or more other operations described herein.

As indicated above, FIG. 1 is provided as an example. Other examples may differ from what is described with regard to FIG. 1.

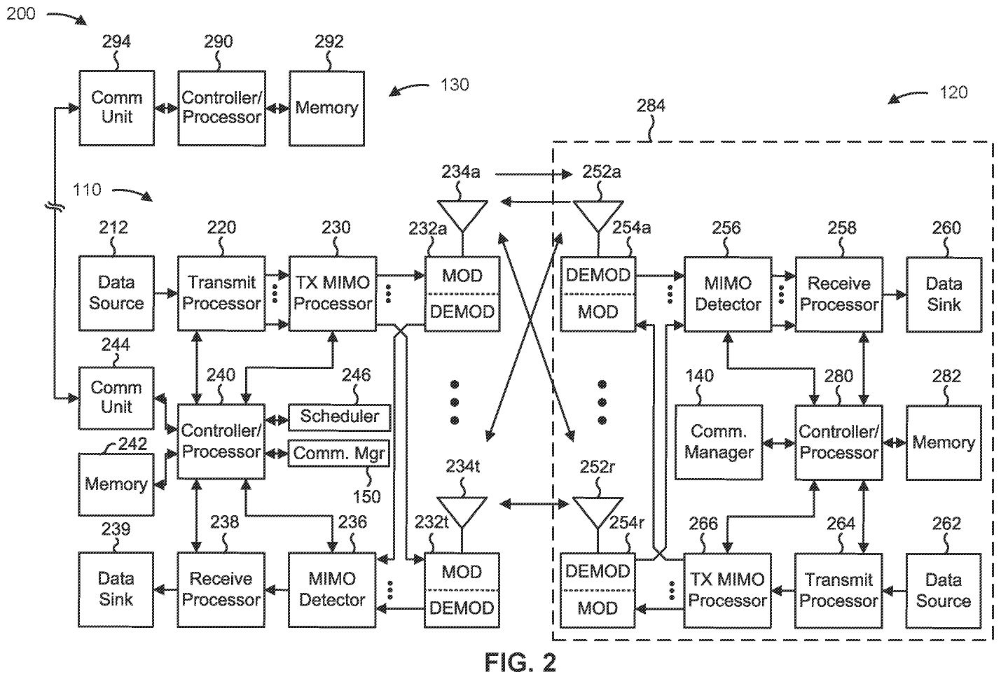

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

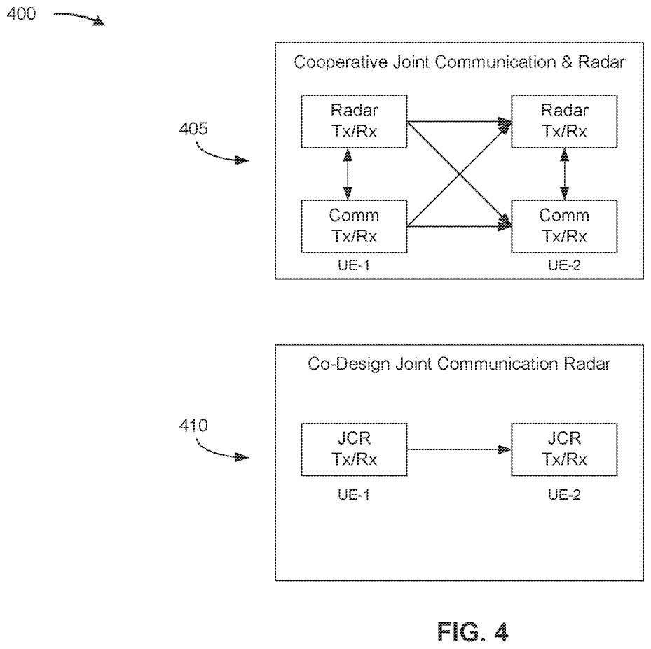

On the uplink, at the UE 120, a transmit processor 264 may receive and process data from a data source 262 and control information (e.g., for reports that include RSRP. RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-13).

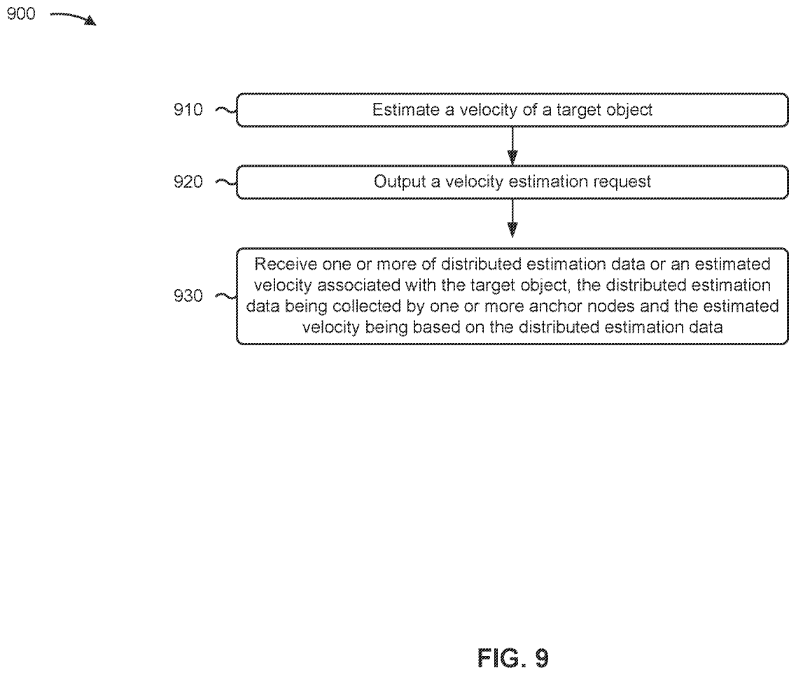

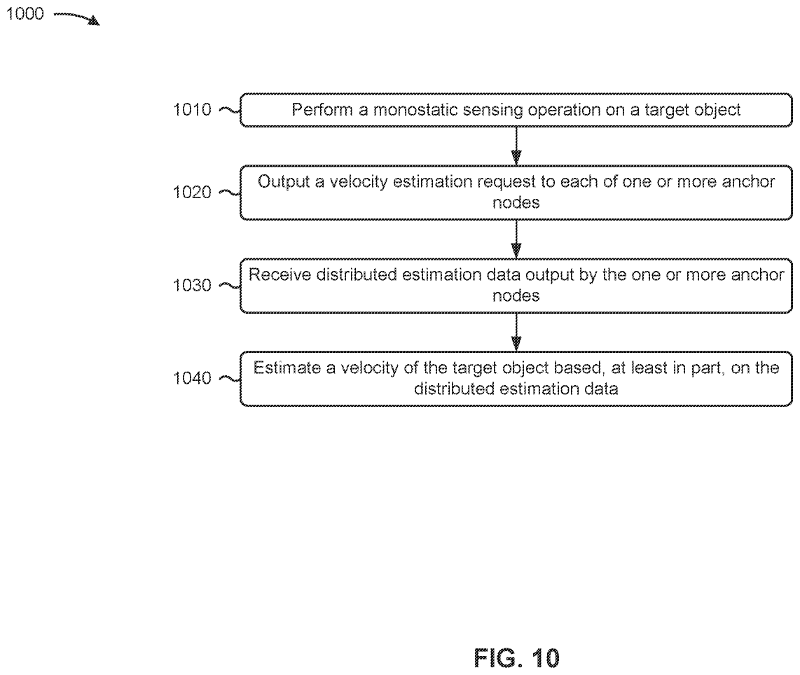

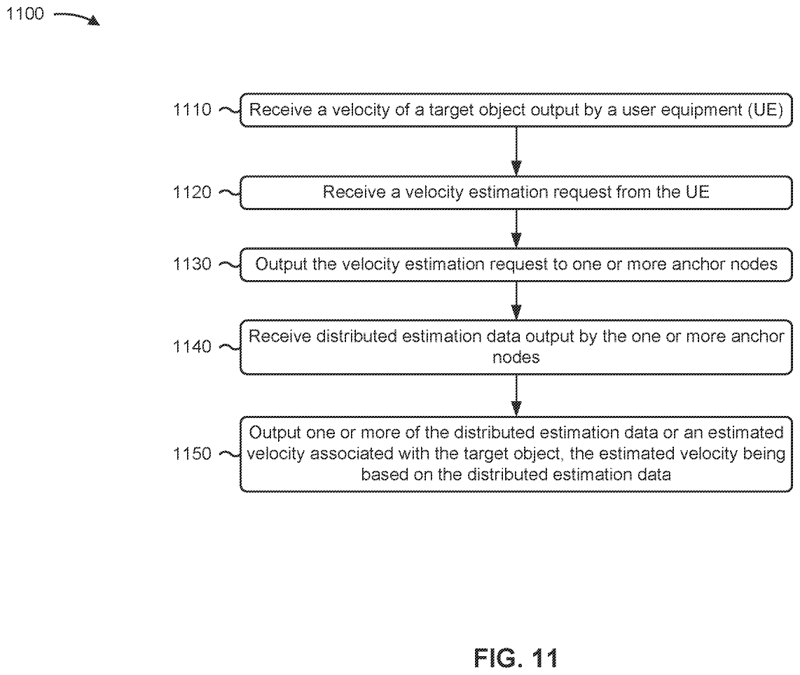

The controller/processor 240 of the network node 110, the controller/processor 280 of the UE 120, and/or any other component(s) of FIG. 2 may perform one or more techniques associated with distributed sensing for velocity estimation, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for estimating a velocity of a target object; means for outputting a velocity estimation request; and/or means for receiving one or more of distributed estimation data or an estimated velocity associated with the target object, the distributed estimation data being collected by one or more anchor nodes and the estimated velocity being based on the distributed estimation data.

In some aspects, the UE 120 includes means for performing a monostatic sensing operation on a target object, means for outputting a velocity estimation request to each of one or more anchor nodes, means for receiving distributed estimation data output by the one or more anchor nodes, and/or means for estimating a velocity of the target object based, at least in part, on the distributed estimation data. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving a velocity of a target object output by a UE; means for receiving a velocity estimation request from the UE; means for outputting the velocity estimation request to one or more anchor nodes; means for receiving distributed estimation data output by the one or more anchor nodes; and/or means for outputting one or more of the distributed estimation data or an estimated velocity associated with the target object, the estimated velocity being based on the distributed estimation data. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

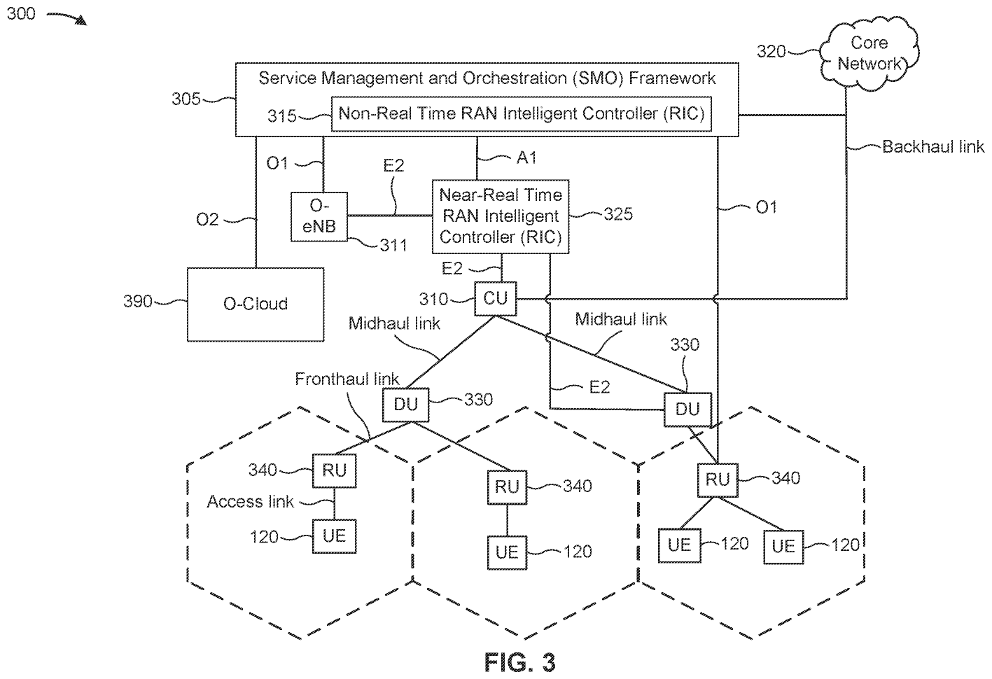

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of cooperative and co-design joint communication and radar systems, in accordance with the present disclosure.

As shown by reference number 405, a cooperative joint communication and radar (JCR) system includes a radar transceiver (shown as Radar Tx/RX in FIG. 4) and a communication transceiver (shown as Comm Tx/Rx in FIG. 4). The radar transceiver may transmit radio waves and receive an echo or return signal, which can be analyzed to determine the distance, size, shape, and/or speed of a target object. The communication transceiver may be configured to transmit and receive signals for wireless communication purposes. In a cooperative joint communication and radar system, a single device (such as a UE 120) may transmit radio waves that carry communication data as well as work like a radar signal, scanning the surrounding environment for target objects. In a cooperative joint communication and radar system, some knowledge is shared between the communication transceiver and radar transceiver to improve their performance without significantly altering the core operation of radar and communication systems. Moreover, the cooperative joint communication and radar system facilitates network efficiencies through spectrum reuse and ease of implementation.

As shown by reference number 410, in a co-design joint communication and radar system, a common transceiver (shown as JCR Tx/Rx in FIG. 4) performs the operations of a radar transceiver and a communication transceiver. Accordingly, the common transceiver can send out and receive radio waves that carry communication data while also scanning the environment for target objects. One benefit of the co-design joint communication and radar system is improved network efficiency through spectrum reuse.

Both cooperative and co-design joint communication and radar systems can be used to implement monostatic and distributed sensing, as will be discussed in greater detail below. For example, cooperative and/or co-design joint communication and radar systems may be implemented in a UE (such as UE 120) to help the UE track one or more target objects. In one use case, the target objects may include vehicles, such as automobiles or airplanes.

As indicated above, FIG. 4 is provided as an example. Other examples may differ from what is described with respect to FIG. 4.

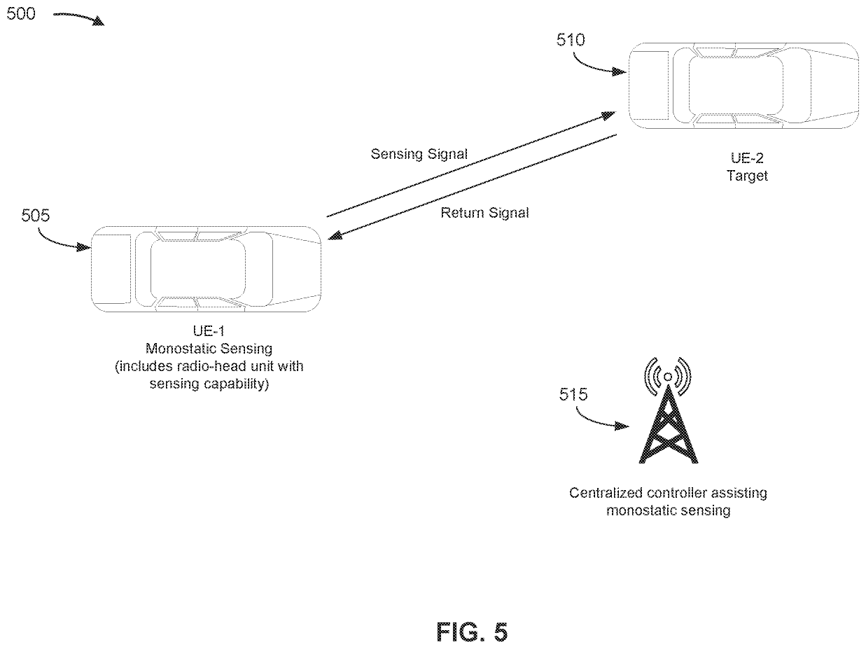

FIG. 5 is a diagram illustrating an example 500 of monostatic sensing using a joint communication and radar system, in accordance with the present disclosure. As shown, a sensing UE 505 uses monostatic sensing to detect a target UE 510. For instance, the sensing UE 505 may use a joint communication and radar system, such as the cooperative or co-design joint communication and radar systems discussed above with respect to FIG. 4, to detect and track movement of the target UE 510.

The sensing UE 505 may transmit a sensing signal toward the target UE 510. The sensing signal may reflect off the target UE 510 and be received at the sensing UE 510 as a return signal. By analyzing the delay and characteristics of the return signal, the sensing UE 505 may derive information about the target UE 510, such as a distance, direction, speed, and/or a combination thereof, among other examples, associated with the target UE 510.

After the sensing UE 505 receives the return signal, the sensing UE 505 may transmit a message to a network node (such as network node 110) serving as a centralized controller 515. The centralized controller 515 may use the information for various purposes, such as managing traffic, assisting in collision avoidance, or optimizing network resource allocation based on the positions and movements of the UEs 505, 510. Moreover, as discussed in greater detail below, the centralized controller 515 may use the information received from multiple sensing UEs 505 to facilitate distributed sensing.

As indicated above, FIG. 5 is provided as an example. Other examples may differ from what is described with respect to FIG. 5.

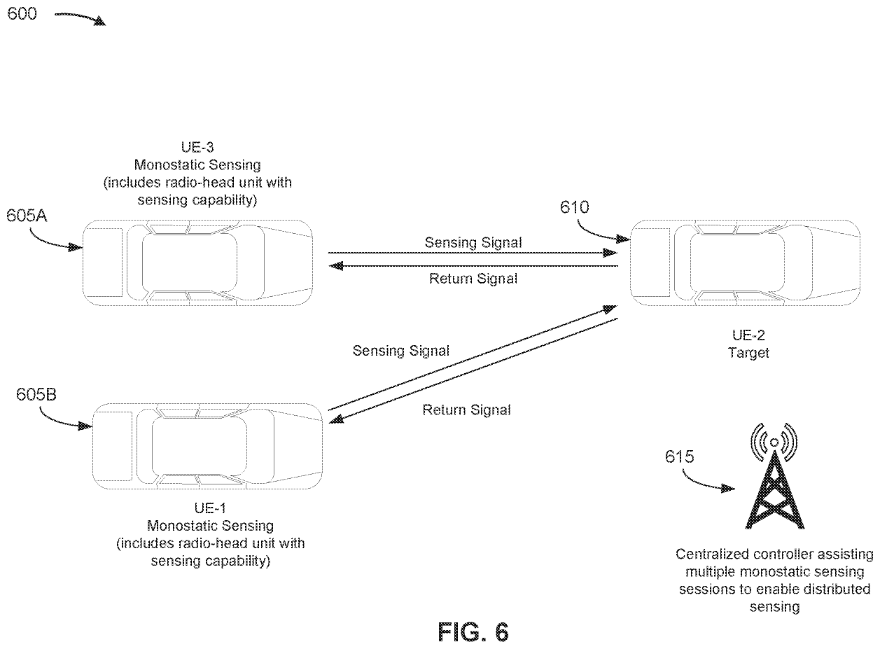

FIG. 6 is a diagram illustrating an example 600 of distributed sensing using a joint communication and radar system, in accordance with the present disclosure. As shown, multiple sensing UEs 605A-605B (collectively, UEs 605), with assistance from a network node (such as a network node 110) serving as a centralized controller 615, use monostatic sensing to detect a target UE 610. Each of the sensing UEs 605 may use a joint communication and radar system, such as the cooperative or co-design joint communication and radar systems discussed above with respect to FIG. 4, to detect and track movement of the target UE 610.

The sensing UEs 605, each performing monostatic sensing using, for example, a joint communication and radar system, may each transmit a sensing signal toward the target UE 610. Further, each sensing UE 605 may receive a return signal when, for example, the sensing signal reflects off the target UE 610. The sensing UEs 605 may independently process the respective return signals received to collect information about the target UE 610, such as a distance, direction, speed, and/or a combination thereof, among other examples, associated with the target UE 610.

Each sensing UE 605 may transmit a message to a network node (such as network node 110) serving as a centralized controller 615 for distributed sensing. The messages may be synchronized in time and/or frequency to, for example, exploit spatial diversity, improve robustness to blockages, improve velocity estimation for target objects moving in arbitrary directions, provide high resolution target localization, identify target shape and volume estimation, improve detection capability, and increase the number of detected targets. The centralized controller 615 may use the information for various purposes, such as managing traffic, assisting in collision avoidance, or optimizing network resource allocation based on the position and movement of the UEs 605, 610. For example, as discussed in greater detail below, in some aspects, the centralized controller 615 may aggregate and transmit information about the target UE 610 to one or more of the sensing UEs 605.

For velocity estimation, a single monostatic sensing UE (such as sensing UE 605) may provide poor velocity estimation accuracy due to a limited coherent processing interval (CPI). A long CPI may be needed for high velocity estimation accuracy, which comes at a cost of high overhead, high processing complexity, and a need for a large buffer. Moreover, there is a relationship between carrier frequency and CPI. Specifically, a lower carrier frequency requires a longer CPI. For example, a velocity estimation resolution requirement for long-range targets may be 0.4 m/s. However, at 28 GHz, a 5 ms CPI will only provide 1 m/s velocity resolution. To achieve 0.4 m/s velocity resolution, the CPI duration may need to be more than doubled (e.g., increased by a factor greater than two). Another issue is that velocity estimation is limited to radial velocity. Therefore, the velocity estimation will be poor for targets moving close to transverse directions relative to the sensing UE, which can result in low velocity estimation accuracy, thereby causing limited clutter cancellation performance as well as poor target path prediction and collision avoidance. One way to improve velocity estimation performance is with distributed sensing with multiple cooperative monostatic sensing UEs 605.

As indicated above, FIG. 6 is provided as an example. Other examples may differ from what is described with respect to FIG. 6.

A velocity estimation of a target object may be derived through monostatic sensing outputs from multiple anchor UE nodes. Consider a target with velocity (vₓ, v_{y}, v_{z}) and location (x, y, z) observed by surrounding K anchor UE nodes that uses monostatic sensing to estimate range and radial velocity. For a k^{th} anchor node with location (xₖ, yₖ, zₖ) that observes a target at range rₖ and velocity vₖ, the radial velocity can be expressed as: (xₖ−x)²+(yₖ−y)²+(zₖ−z)²=rₖ². Differentiating as a function of time t provides: (xₖ−x)vₓ+(yₖ−y)v_{y}+(zₖ−z)v_{z}=−rₖvₖ. Assuming that target location (x, y, z) is known at the centralized controller or can be estimated using multi-static positioning methods, the equation becomes the following:

$$[ \begin{matrix}( {x}_{1} - x ) & ( {y}_{1} - y ) & ( {z}_{1} - z ) \\ ( {x}_{2} - x ) & ( {y}_{2} - y ) & ( {z}_{2} - z ) \\ ( {x}_{3} - x ) & ( {y}_{3} - y ) & ( {z}_{3} - z )\end{matrix} ] [ \begin{matrix}{v}_{x} \\ {v}_{y} \\ {v}_{z}\end{matrix} ] = - [ \begin{matrix}{r}_{1} {v}_{1} \\ {r}_{2} {v}_{2} \\ {r}_{3} {v}_{3}\end{matrix} ]$$

In the above expression, the first matrix, with the location vectors (x, y, z), can be simplified as A, the second matrix, with the velocity vector (vₓ, v_{y}, v_{z}), can be simplified as v, and the third matrix with the radial velocity vector can be simplified as b. Accordingly, the above expression can be simplified as v=A⁻¹b.

The multi-dimensional, multi-anchor case is an extension of the above expression and can be solved using the least squares estimate: v=(A^{T}A)⁻¹A^{T}b. As the number of anchor UE nodes, and the number of corresponding monostatic measurements, increase, the velocity estimation would accordingly become more accurate.

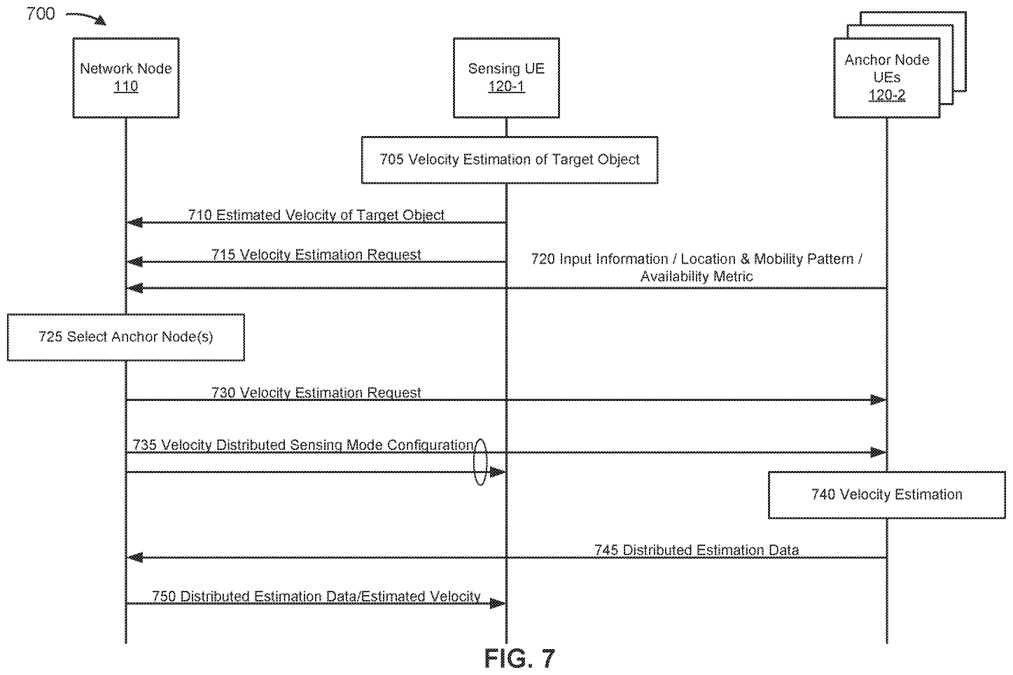

FIG. 7 is a diagram illustrating an example 700 associated with distributed sensing for velocity estimation, in accordance with the present disclosure. As shown in FIG. 7, a network node 110 may communicate with a sensing UE 120-1 and one or more anchor node UEs 120-2. The sensing UE 120-1 and/or the anchor node UEs 120-2 may be incorporated into dynamic objects (e.g., objects that move, such as vehicles), static objects (e.g., objects that are stationary, such as a network node or a roadside unit, among other examples), and/or a combination thereof, among other examples.

As shown by reference number 705, the sensing UE 120-1 may estimate a velocity of a target object. For example, the sensing UE 120-1 may perform a monostatic sensing operation to sense the velocity of the target object by transmitting a sensing signal toward the target object and estimating the velocity of the target object based on a return signal that reflects off the target object.

As shown by reference number 710, the sensing UE 120-1 may transmit, and the network node 110 may receive, the estimated velocity of the target object. The estimated velocity of the target object may be based, at least in part, on the monostatic sensing operation performed by the sensing UE 120-1, discussed above with respect to reference number 705.

As shown by reference number 715, the sensing UE 120-1 may transmit, and the network node 110 may receive, a velocity estimation request. The velocity estimation request may include a coarse location of the target object. The coarse location of the target object may be based, at least in part, on the monostatic sensing operation performed by the sensing UE 120-1, discussed above with respect to reference number 705. In some aspects, the velocity estimation request may include a performance error metric. The performance error metric may include one or more of a velocity estimation resolution, a predicted covariance, a velocity estimation accuracy value, and/or a combination thereof, among other examples.

As shown by reference number 720, the anchor node UEs 120-2 may individually transmit, and the network node 110 may receive, input information, a location and mobility pattern, an availability metric, and/or a combination thereof, among other examples. The input information may include one or more transmit parameters, one or more processing capabilities, and/or a combination thereof, among other examples, associated with the anchor node UE 120-2. The transmit parameters or processing capabilities may include a supported cell positioning information range, supported comb patterns, a velocity accuracy value, a supported maximum unambiguous velocity value, a field of view, and/or a combination thereof, among other examples. The location or mobility pattern associated with the anchor node UE 120-2 may refer to a location of the anchor node UE 120-2. The location may be relative to the sensing UE 120-1, relative to the network node 110, relative to the target object, or fixed, among other examples. The mobility pattern may indicate a route or other movement associated with the anchor node UE 120-2. The availability metric may include a start time, a stop time, symbols available between the start time and stop time, slots available between the start time and stop time, a restricted beam direction associated with one or more of the symbols or slots, a transmit power, and/or a combination thereof, among other examples.

As shown by reference number 725, the network node 110 may select one or more of the anchor node UEs 120-2 for a distributed sensing operation. The one or more anchor node UEs 120-2 may be selected based, at least in part, on the target information, the input information, and/or a combination thereof, among other examples, received by the network node 110. In some aspects, the anchor node UEs 120-2 are selected based on one or more feasibility factors, each associated with one or more of the anchor node UEs 120-2. The feasibility factors may include a distance of a respective anchor node UE 120-2 to the target object, a direction of the respective anchor node 120-2 to the target object, a direction of the respective anchor node UE 120-2 to the sensing UE 120-1, prior channel information, and/or a combination thereof, among other examples. By way of example, the network node 110 may select anchor node UEs 120-2 that are near the target object, travelling in the same direction as the target object, and with no obstructions that could interfere with the distributed sensing operation with respect to measuring the velocity of the target object. Moreover, anchor node UEs 120-2 with a relative direction different from the direction of the sensing UE 120-1, relative to the target object, may improve spatial diversity and increase the estimation accuracy of the transversal velocity.

As shown by reference number 730, the network node 110 may transmit, and the selected anchor node UEs 120-2 may receive, the velocity estimation request. As discussed above with respect to reference number 715, the velocity estimation request may include a coarse location of the target object, one or more performance error metrics, and/or a combination thereof, among other examples. In some aspects, the anchor node UEs 120-1 may respond to the network node 110 with an acknowledgement.

As shown by reference number 735, the network node 110 may transmit, and the sensing UE 120-1 and the anchor node UEs 120-2 may receive, a velocity distributed sensing mode configuration. The velocity distributed sensing mode configuration may include transmission and/or reception configurations for the sensing UE 120-1, the anchor node UEs 120-2, and/or a combination thereof, among other examples. In some aspects, the velocity distributed sensing configuration may allocate resources for the sensing UE 120-1, the anchor node UEs 120-2, and/or a combination thereof, among other examples, to perform a monostatic sensing operation with respect to the target object and transmit the results of the monostatic sensing operation to the network node 110. In accordance with the velocity distributed sensing mode configuration, in some aspects, each anchor node UE 120-2 may transmit a waveform, between other anchor node UEs 120-2, via time division multiplexing (TDM). In some aspects, the waveform transmitted between anchor node UEs 120-2 may be staggered with a certain periodicity, for example, on a first symbol for a first anchor node UE, a second symbol for a second anchor node UE, a kth symbol for a kth anchor node UE, and so on. In some aspects, the selected anchor node UEs 120-2 may be configured to operate in multi-static sensing mode. When operating in the multi-static sensing mode, the velocity distributed sensing mode configuration may include parameters indicating whether one or more of the anchor node UEs 120-2 will be used to transmit sensing waveforms, receive sensing waveforms, or both. In some aspects, one or more of the anchor node UEs 120-2 may be configured with start and stop times, and symbols or slots, to sense a target echo within the start and stop time, a start and stop frequency as well as resource blocks to be used within the start and stop frequency, beam directions to be used at each symbol/slot, and/or a periodicity, among other examples, when performing the receiving function of the distributed sensing operation. Alternatively or in addition, in some aspects, one or more of the anchor node UEs 120-2, such as anchor node UEs 120-2 performing the transmit function of the distributed sensing operation, may be configured with parameters, such as a location and velocity of the anchor node UEs 120-2 performing the receiving function. The configuration may configure the anchor node UEs 120-2 performing the transmit function to synchronize and translate the velocity estimates determined by the anchor node UEs 120-2 performing the receiving function with the velocity estimate of the anchor node UE 120-2 performing the transmitting function. “Translating” the velocity estimate may refer to compensating for differences in geographic locations of the anchor node UEs 120-2 relative to the target object.

As shown by reference number 740, the anchor node UEs 120-2 may perform a velocity estimation of the target object. The velocity estimation may be performed in accordance with the velocity distributed sensing mode configuration discussed above with regard to reference number 735. For example, the anchor node UEs 120-2 may each perform a monostatic sensing operation to gather information that can be used to estimate the velocity of the target object.

As shown by reference number 745, the anchor node UEs 120-2 may transmit, and the network node 110 may receive, distributed estimation data. The distributed estimation data may include or indicate the velocity of the target object as estimated by each of the anchor node UEs 120-2.

As shown by reference number 750, the network node 110 may transmit, and the sensing UE 120-1 may receive, aggregated distributed estimation data, an estimated velocity based on the aggregated distributed estimation data, and/or a combination thereof, among other examples. For example, the network node 110 may forward the distributed estimation data received from each of the anchor node UEs 120-2 so that the sensing UE 120-1 can process the distributed estimation data and estimate the velocity of the target object based, at least in part, on the distributed estimation data. Alternatively, the network node 110 may process the distributed estimation data, along with the estimated velocity of the target object measured by the sensing UE 120-1, to determine an updated, and possibly more accurate, velocity estimate of the target object.

In some aspects, the distributed sensing operations of example 700 may be iteratively triggered with, for example, modified parameters for refining the velocity estimation of a previous iteration. Alternatively or in addition, the modified parameters may be used to optimize the transmission power of one or more anchor node UEs 120-2 if, for example, the network node 110 does not receive an acknowledgement from one or more of the anchor node UEs 120-2.

In some aspects, the velocity estimation request transmitted from the network node 110 to the anchor node UEs 120-2 may include the initial velocity estimate of the sensing UE 120-1 as a parameter if, for example, the sensing UE 120-1 estimated the velocity of the target object with a point target model. Alternatively, the initial velocity estimate may be provided in the velocity estimation request as a center velocity with a velocity spread. In some aspects, the velocity estimation request may include a signal-to-noise ratio associated with the monostatic sensing operation performed by the sensing UE 120-1.

In some aspects, the sensing UE 120-1, the anchor node UEs 120-2, or both, may transmit a sounding reference signal or a frequency modulated continuous wave as the sensing signal in the monostatic sensing operation. In some aspects, such as for joint communication and sensing with a common waveform, such as CP-OFDM data in monostatic mode, the anchor node UEs 120-2 that are already configured to transmit in the same communication direction as the desired distributed sensing direction (e.g., toward the target object), can be configured to enhance estimation of the velocity of the target object.

In some aspects, the network node 110 may be requested to assist in improving the velocity estimate for one or more targets from one or more sensing UEs 120-1. Accordingly, the network node 110 may configure a periodic request time frame for handling requests from one or more sensing UEs 120-1 with respect to one or more target objects. In one aspect, one of the sensing UEs 120-1 (which may be referred to as an initial sensing UE 120-1) may be configured to request, during the time frame, a configuration for estimating target velocity parameters for more than one target object. Alternatively, multiple sensing UEs 120-1 may be configured to request, during the time frame, a configuration for initiating the distributed sensing mode for velocity estimation with respect to one or more targets.

In some aspects, the network node 110 may be configured to initiate a periodic distributed sensing mode to estimate velocity parameters of certain target objects, such as targets of interest. The targets of interest may include target objects in pre-determined locations, such as high collision zones, schools, and/or a combination thereof, among other examples. The targets of interest may be dynamically determined based on the sensing result reports transmitted by one or more sensing UEs 120-1.

Accordingly, the sensing UE 120-1 may receive or calculate a more accurate estimate of the velocity of the target object through distributed sensing even though each anchor node UE 120-2 is individually performing a monostatic sensing operation.

As indicated above, FIG. 7 is provided as an example. Other examples may differ from what is described with respect to FIG. 7.

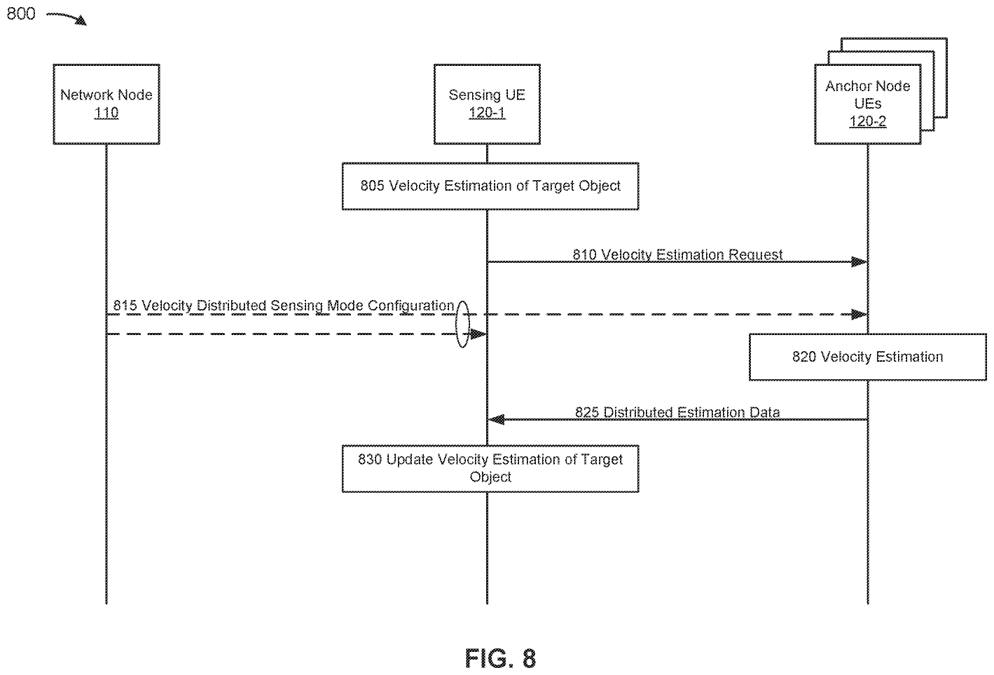

FIG. 8 is a diagram illustrating an example 800 associated with distributed sensing for velocity estimation using sidelink, in accordance with the present disclosure. As shown in FIG. 8, a sensing UE 120-1 may communicate with one or more anchor node UEs 120-2.

As shown by reference number 805, the sensing UE 120-1 may estimate a velocity of a target object. For example, the sensing UE 120-1 may perform a monostatic sensing operation to sense the velocity of the target object by transmitting a sensing signal toward the target object and estimating the velocity of the target object based on a return signal that reflects off the target object.

As shown by reference number 810, the sensing UE 120-1 may transmit, and the anchor node UEs 120-2 may receive, a velocity estimation request. The velocity estimation request may include a coarse location of the target object. The coarse location of the target object may be based, at least in part, on the monostatic sensing operation performed by the sensing UE 120-1, discussed above with respect to reference number 805. In some aspects, the velocity estimation request may include a performance error metric. The performance error metric may include one or more of a velocity estimation resolution, a predicted covariance, a velocity estimation accuracy value, and/or a combination thereof, among other examples. In some aspects, the anchor node UEs 120-1 may respond to the sensing UE 120-1 with an acknowledgement.

As shown by reference number 815, the network node 110 may transmit, and the sensing UE 120-1 and the anchor node UEs 120-2 may receive, a velocity distributed sensing mode configuration. The velocity distributed sensing mode configuration may include transmission and/or reception configurations for the sensing UE 120-1, the anchor node UEs 120-2, and/or a combination thereof, among other examples. In some aspects, the velocity distributed sensing mode configuration may allocate resources for the sensing UE 120-1, the anchor node UEs 120-2, and/or a combination thereof, among other examples, to perform a monostatic sensing operation with respect to the target object and transmit the results of the monostatic sensing operation to the network node 110. In some aspects, the network node 110 may not need to transmit the velocity distributed sensing mode configuration. For example, the velocity distributed sensing mode configuration may not be necessary if the sensing UE 120-1 and the anchor node UEs 120-2 communicate on sidelink resources via a sidelink interface, such as the PC5 interface.

As shown by reference number 820, the anchor node UEs 120-2 may perform a velocity estimation of the target object. The velocity estimation may be performed in accordance with the velocity distributed sensing mode configuration discussed above with regard to reference number 815, if received. In some aspects, the anchor node UEs 120-2 may each perform a monostatic sensing operation to gather information that can be used to estimate the velocity of the target object.

As shown by reference number 825, the anchor node UEs 120-2 may transmit, and the sensing UE 120-1 may receive, distributed estimation data. The distributed estimation data may include or indicate the velocity of the target object as estimated by each of the anchor node UEs 120-2.

As shown by reference number 830, the sensing UE 120-1 may process the distributed estimation data received from the anchor node UEs 120-1 and update the estimate of the velocity of the target object based, at least in part, on the distributed estimation data. Because the updated velocity estimation is based on multiple data sources (e.g., velocity estimates performed by each of the anchor node UEs 120-2), the updated velocity estimation may be more accurate than the velocity estimation performed by the sensing UE 120-1, discussed above with respect to reference number 805. Moreover, because at least some of the communications in the example 800 occur via sidelink or without significant interaction from the network node 110, the sensing UE 120-1 may receive the benefits of distributed sensing (e.g., increased accuracy) without significantly increasing the burden on the network.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with distributed sensing for velocity estimation.

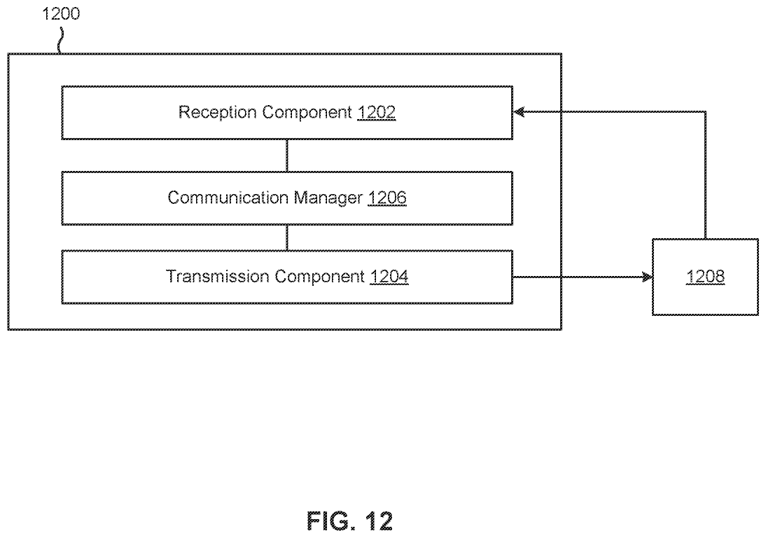

As shown in FIG. 9, in some aspects, process 900 may include estimating a velocity of a target object (block 910). For example, the UE (e.g., using communication manager 1206, depicted in FIG. 12) may estimate a velocity of a target object, as described above.

As further shown in FIG. 9, in some aspects, process 900 may include outputting a velocity estimation request (block 920). For example, the UE (e.g., using transmission component 1204 and/or communication manager 1206, depicted in FIG. 12) may output a velocity estimation request, as described above.

As further shown in FIG. 9, in some aspects, process 900 may include receiving one or more of distributed estimation data or an estimated velocity associated with the target object, the distributed estimation data being collected by one or more anchor nodes and the estimated velocity being based on the distributed estimation data (block 930). For example, the UE (e.g., using reception component 1202 and/or communication manager 1206, depicted in FIG. 12) may receive one or more of distributed estimation data or an estimated velocity associated with the target object, the distributed estimation data being collected by one or more anchor nodes and the estimated velocity being based on the distributed estimation data, as described above.

Process 900 may include additional aspects, such as any single aspect or any combination of aspects described below and/or in connection with one or more other processes described elsewhere herein.

In a first aspect, the velocity estimation request includes a coarse location of the target object.

In a second aspect, alone or in combination with the first aspect, the velocity estimation request includes a performance error metric.

In a third aspect, alone or in combination with one or more of the first and second aspects, the performance error metric includes one or more of a velocity estimation resolution or a predicted covariance.

In a fourth aspect, alone or in combination with one or more of the first through third aspects, the performance error metric includes a velocity estimation accuracy value.

In a fifth aspect, alone or in combination with one or more of the first through fourth aspects, process 900 includes receiving a configuration for a velocity distributed sensing mode.

In a sixth aspect, alone or in combination with one or more of the first through fifth aspects, process 900 includes transmitting a request to initiate the velocity distributed sensing mode.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with distributed sensing for velocity estimation.

As shown in FIG. 10, in some aspects, process 1000 may include performing a monostatic sensing operation on a target object (block 1010). For example, the UE (e.g., using communication manager 1206, depicted in FIG. 12) may perform a monostatic sensing operation on a target object, as described above.

As further shown in FIG. 10, in some aspects, process 1000 may include outputting a velocity estimation request to each of one or more anchor nodes (block 1020). For example, the UE (e.g., using transmission component 1204 and/or communication manager 1206, depicted in FIG. 12) may output a velocity estimation request to each of one or more anchor nodes, as described above.

As further shown in FIG. 10, in some aspects, process 1000 may include receiving distributed estimation data output by the one or more anchor nodes (block 1030). For example, the UE (e.g., using reception component 1202 and/or communication manager 1206, depicted in FIG. 12) may receive distributed estimation data output by the one or more anchor nodes, as described above.

As further shown in FIG. 10, in some aspects, process 1000 may include estimating a velocity of the target object based, at least in part, on the distributed estimation data (block 1040). For example, the UE (e.g., using communication manager 1206, depicted in FIG. 12) may estimate a velocity of the target object based, at least in part, on the distributed estimation data, as described above.

Process 1000 may include additional aspects, such as any single aspect or any combination of aspects described below and/or in connection with one or more other processes described elsewhere herein.

In a first aspect, the velocity estimation request includes a coarse location of the target object.

In a second aspect, alone or in combination with the first aspect, the velocity estimation request includes a performance error metric.

In a third aspect, alone or in combination with one or more of the first and second aspects, the performance error metric includes one or more of a velocity estimation resolution or a predicted covariance.

In a fourth aspect, alone or in combination with one or more of the first through third aspects, the performance error metric includes a velocity estimation accuracy value.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with distributed sensing for velocity estimation.

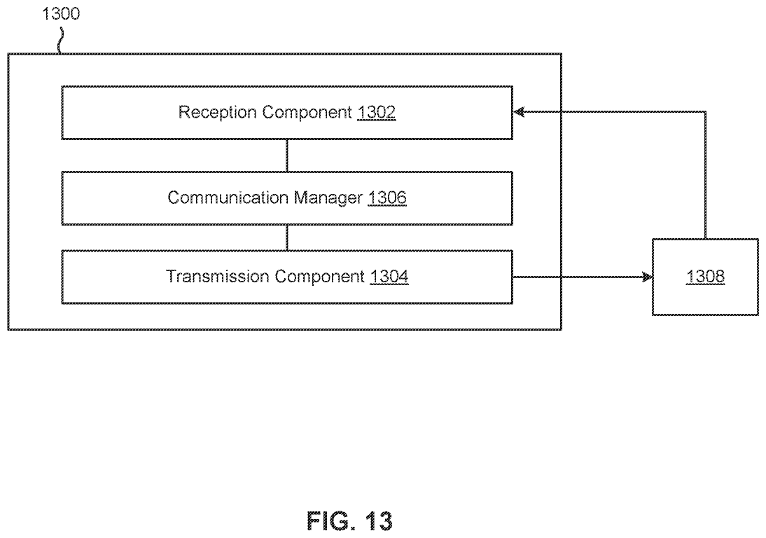

As shown in FIG. 11, in some aspects, process 1100 may include receiving a velocity of a target object output by a UE (block 1110). For example, the network node (e.g., using reception component 1302 and/or communication manager 1306, depicted in FIG. 13) may receive a velocity of a target object output by a UE, as described above.

As further shown in FIG. 11, in some aspects, process 1100 may include receiving a velocity estimation request from the UE (block 1120). For example, the network node (e.g., using reception component 1302 and/or communication manager 1306, depicted in FIG. 13) may receive a velocity estimation request from the UE, as described above.

As further shown in FIG. 11, in some aspects, process 1100 may include outputting the velocity estimation request to one or more anchor nodes (block 1130). For example, the network node (e.g., using transmission component 1304 and/or communication manager 1306, depicted in FIG. 13) may output the velocity estimation request to one or more anchor nodes, as described above.

As further shown in FIG. 11, in some aspects, process 1100 may include receiving distributed estimation data output by the one or more anchor nodes (block 1140). For example, the network node (e.g., using reception component 1302 and/or communication manager 1306, depicted in FIG. 13) may receive distributed estimation data output by the one or more anchor nodes, as described above.

As further shown in FIG. 11, in some aspects, process 1100 may include outputting one or more of the distributed estimation data or an estimated velocity associated with the target object, the estimated velocity being based on the distributed estimation data (block 1150). For example, the network node (e.g., using transmission component 1304 and/or communication manager 1306, depicted in FIG. 13) may output one or more of the distributed estimation data or an estimated velocity associated with the target object, the estimated velocity being based on the distributed estimation data, as described above.

Process 1100 may include additional aspects, such as any single aspect or any combination of aspects described below and/or in connection with one or more other processes described elsewhere herein.

In a first aspect, the velocity estimation request includes a coarse location of the target object.

In a second aspect, alone or in combination with the first aspect, the velocity estimation request includes a performance error metric.

In a third aspect, alone or in combination with one or more of the first and second aspects, the performance error metric includes one or more of a velocity estimation resolution or a predicted covariance.

In a fourth aspect, alone or in combination with one or more of the first through third aspects, the performance error metric includes a velocity estimation accuracy value.

In a fifth aspect, alone or in combination with one or more of the first through fourth aspects, process 1100 includes transmitting a configuration for a velocity distributed sensing mode.

In a sixth aspect, alone or in combination with one or more of the first through fifth aspects, process 1100 includes receiving a request to initiate the velocity distributed sensing mode.

In a seventh aspect, alone or in combination with one or more of the first through sixth aspects, process 1100 includes selecting the one or more anchor nodes based, at least in part, on one or more feasibility factors, each of the one or more feasibility factors being associated with one or more of the one or more anchor nodes.

In an eighth aspect, alone or in combination with one or more of the first through seventh aspects, at least one of the one or more feasibility factor being based, at least in part, on one or more of a distance of a respective anchor node to the target object, a direction of the respective anchor node relative to the target object, a direction of the respective anchor node relative to the UE, or prior channel information, wherein the respective anchor node is one of the one or more anchor nodes.

In a ninth aspect, alone or in combination with one or more of the first through eighth aspects, process 1100 includes receiving input information from the one or more anchor nodes.

In a tenth aspect, alone or in combination with one or more of the first through ninth aspects, the input information includes one or more transmit parameters or one or more processing capabilities associated with at least one of the one or more anchor nodes.

In an eleventh aspect, alone or in combination with one or more of the first through tenth aspects, the one or more transmit parameters or the one or more processing capabilities include one or more of a supported cell positioning information range, one or more supported comb patterns, a velocity accuracy value, a supported maximum unambiguous velocity value, or a field of view.

In a twelfth aspect, alone or in combination with one or more of the first through eleventh aspects, process 1100 includes receiving one or more of a location or mobility pattern associated with each of the anchor nodes.

In a thirteenth aspect, alone or in combination with one or more of the first through twelfth aspects, process 1100 includes receiving an availability metric associated with each of the one or more anchor nodes.

In a fourteenth aspect, alone or in combination with one or more of the first through thirteenth aspects, the availability metric includes one or more of a start time, a stop time, symbols available between the start time and stop time, slots available between the start time and stop time, a restricted beam direction associated with one or more of the symbols or slots, or a transmit power.

In a fifteenth aspect, alone or in combination with one or more of the first through fourteenth aspects, process 1100 includes selecting the one or more anchor nodes based, at least in part, on target information and input information from the one or more anchor nodes.

In a sixteenth aspect, alone or in combination with one or more of the first through fifteenth aspects, process 1100 includes configuring the anchor nodes to perform a monostatic sensing operation.

In a seventeenth aspect, alone or in combination with one or more of the first through sixteenth aspects, configuring the one or more anchor nodes to perform the monostatic sensing operation includes configuring transmit waveforms of the one or more anchor nodes or configuring one or more transmit parameters of the one or more anchor nodes.

In an eighteenth aspect, alone or in combination with one or more of the first through seventeenth aspects, the one or more anchor nodes include one or more static objects.

In a nineteenth aspect, alone or in combination with one or more of the first through eighteenth aspects, the one or more anchor nodes include one or more dynamic objects.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4-8. Additionally, or alternatively, the apparatus 1200 may be configured to perform one or more processes described herein, such as process 900 of FIG. 9, process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

In some aspects, the communication manager 1206 may estimate a velocity of a target object. The transmission component 1204 may output a velocity estimation request. The reception component 1202 may receive one or more of distributed estimation data or an estimated velocity associated with the target object, the distributed estimation data being collected by one or more anchor nodes and the estimated velocity being based on the distributed estimation data. The reception component 1202 may receive a configuration for a velocity distributed sensing mode. The transmission component 1204 may transmit a request to initiate the velocity distributed sensing mode.

In some aspects, the communication manager 1206 may perform a monostatic sensing operation on a target object. The transmission component 1204 may output a velocity estimation request to each of one or more anchor nodes. The reception component 1202 may receive distributed estimation data output by the one or more anchor nodes. The communication manager 1206 may estimate a velocity of the target object based, at least in part, on the distributed estimation data.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 4-8. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive a velocity of a target object output by a UE. The reception component 1302 may receive a velocity estimation request from the UE. The transmission component 1304 may output the velocity estimation request to one or more anchor nodes. The reception component 1302 may receive distributed estimation data output by the one or more anchor nodes. The transmission component 1304 may output one or more of the distributed estimation data or an estimated velocity associated with the target object, the estimated velocity being based on the distributed estimation data. The transmission component 1304 may transmit a configuration for a velocity distributed sensing mode. The reception component 1302 may receive a request to initiate the velocity distributed sensing mode. The communication manager 1306 may select the one or more anchor nodes based, at least in part, on one or more feasibility factors, each of the one or more feasibility factors being associated with one or more of the one or more anchor nodes.

The reception component 1302 may receive input information from the one or more anchor nodes. The reception component 1302 may receive one or more of a location or mobility pattern associated with each of the anchor nodes. The reception component 1302 may receive an availability metric associated with each of the one or more anchor nodes.

The communication manager 1306 may select the one or more anchor nodes based, at least in part, on target information and input information from the one or more anchor nodes. The communication manager 1306 may configure the anchor nodes to perform a monostatic sensing operation.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a UE, comprising: estimating a velocity of a target object; outputting a velocity estimation request; and receiving one or more of distributed estimation data or an estimated velocity associated with the target object, the distributed estimation data being collected by one or more anchor nodes and the estimated velocity being based on the distributed estimation data.

Aspect 2: The method of Aspect 1, wherein the velocity estimation request includes a coarse location of the target object.

Aspect 3: The method of any of Aspects 1-2, wherein the velocity estimation request includes a performance error metric.

Aspect 4: The method of Aspect 3, wherein the performance error metric includes one or more of a velocity estimation resolution or a predicted covariance.

Aspect 5: The method of Aspect 3, wherein the performance error metric includes a velocity estimation accuracy value.

Aspect 6: The method of any of Aspects 1-5, further comprising receiving a configuration for a velocity distributed sensing mode.

Aspect 7: The method of Aspect 6, further comprising transmitting a request to initiate the velocity distributed sensing mode.

Aspect 8: A method of wireless communication performed by a UE, comprising: performing a monostatic sensing operation on a target object; outputting a velocity estimation request to each of one or more anchor nodes; receiving distributed estimation data output by the one or more anchor nodes; and estimating a velocity of the target object based, at least in part, on the distributed estimation data.

Aspect 9: The method of Aspect 8, wherein the velocity estimation request includes a coarse location of the target object.

Aspect 10: The method of any of Aspects 8-9, wherein the velocity estimation request includes a performance error metric.

Aspect 11: The method of Aspect 10, wherein the performance error metric includes one or more of a velocity estimation resolution or a predicted covariance.

Aspect 12: The method of Aspect 10, wherein the performance error metric includes a velocity estimation accuracy value.

Aspect 13: A method of wireless communication performed by a network node, comprising: receiving a velocity of a target object output by a UE; receiving a velocity estimation request from the UE; outputting the velocity estimation request to one or more anchor nodes; receiving distributed estimation data output by the one or more anchor nodes; and outputting one or more of the distributed estimation data or an estimated velocity associated with the target object, the estimated velocity being based on the distributed estimation data.

Aspect 14: The method of Aspect 13, wherein the velocity estimation request includes a coarse location of the target object.

Aspect 15: The method of any of Aspects 13-14, wherein the velocity estimation request includes a performance error metric.

Aspect 16: The method of Aspect 15, wherein the performance error metric includes one or more of a velocity estimation resolution or a predicted covariance.

Aspect 17: The method of Aspect 15, wherein the performance error metric includes a velocity estimation accuracy value.

Aspect 18: The method of any of Aspects 13-17, further comprising transmitting a configuration for a velocity distributed sensing mode.

Aspect 19: The method of Aspect 18, further comprising receiving a request to initiate the velocity distributed sensing mode.

Aspect 20: The method of any of Aspects 13-19, further comprising selecting the one or more anchor nodes based, at least in part, on one or more feasibility factors, each of the one or more feasibility factors being associated with one or more of the one or more anchor nodes.

Aspect 21: The method of Aspect 20, wherein at least one of the one or more feasibility factors are based, at least in part, on one or more of a distance of a respective anchor node to the target object, a direction of the respective anchor node relative to the target object, a direction of the respective anchor node relative to the UE, or prior channel information, wherein the respective anchor node is one of the one or more anchor nodes.

Aspect 22: The method of any of Aspects 13-21, further comprising receiving input information from the one or more anchor nodes.

Aspect 23: The method of Aspect 22, wherein the input information includes one or more transmit parameters or one or more processing capabilities associated with at least one of the one or more anchor nodes.

Aspect 24: The method of Aspect 23, wherein the one or more transmit parameters or the one or more processing capabilities include one or more of a supported cell positioning information range, one or more supported comb patterns, a velocity accuracy value, a supported maximum unambiguous velocity value, or a field of view.

Aspect 25: The method of any of Aspects 13-24, further comprising receiving one or more of a location or mobility pattern associated with each of the anchor nodes.

Aspect 26: The method of any of Aspects 13-25, further comprising receiving an availability metric associated with each of the one or more anchor nodes.

Aspect 27: The method of Aspect 26, wherein the availability metric includes one or more of a start time, a stop time, symbols available between the start time and stop time, slots available between the start time and stop time, a restricted beam direction associated with one or more of the symbols or slots, or a transmit power.

Aspect 28: The method of any of Aspects 13-27, further comprising selecting the one or more anchor nodes based, at least in part, on target information and input information from the one or more anchor nodes.

Aspect 29: The method of any of Aspects 13-28, further comprising configuring the anchor nodes to perform a monostatic sensing operation.

Aspect 30: The method of Aspect 29, wherein configuring the one or more anchor nodes to perform the monostatic sensing operation includes configuring transmit waveforms of the one or more anchor nodes or configuring one or more transmit parameters of the one or more anchor nodes.

Aspect 31: The method of any of Aspects 13-30, wherein the one or more anchor nodes include one or more static objects.

Aspect 32: The method of any of Aspects 13-31, wherein the one or more anchor nodes include one or more dynamic objects.

Aspect 33: An apparatus for wireless communication at a device, comprising a processor; memory coupled with the processor; and instructions stored in the memory and executable by the processor to cause the apparatus to perform the method of one or more of Aspects 1-32.

Aspect 34: A device for wireless communication, comprising a memory and one or more processors coupled to the memory, the one or more processors configured to perform the method of one or more of Aspects 1-32.

Aspect 35: An apparatus for wireless communication, comprising at least one means for performing the method of one or more of Aspects 1-32.

Aspect 36: A non-transitory computer-readable medium storing code for wireless communication, the code comprising instructions executable by a processor to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
estimate a velocity of a target object;
output a velocity estimation request; and
receive one or more of distributed estimation data or an estimated velocity associated with the target object, the distributed estimation data being collected by one or more anchor nodes and the estimated velocity being based on the distributed estimation data.

2. The UE of claim 1, wherein the velocity estimation request includes a coarse location of the target object.

3. The UE of claim 1, wherein the velocity estimation request includes a performance error metric.

4. The UE of claim 3, wherein the performance error metric includes one or more of a velocity estimation resolution or a predicted covariance.

5. The UE of claim 3, wherein the performance error metric includes a velocity estimation accuracy value.

6. The UE of claim 1, wherein the one or more processors are further configured to receive a configuration for a velocity distributed sensing mode.

7. The UE of claim 6, wherein the one or more processors are further configured to transmit a request to initiate the velocity distributed sensing mode.

8. A user equipment (UE) for wireless communication, comprising:
a memory; and
one or more processors, coupled to the memory, configured to:
perform a monostatic sensing operation on a target object;
output a velocity estimation request to each of one or more anchor nodes;
receive distributed estimation data output by the one or more anchor nodes; and
estimate a velocity of the target object based, at least in part, on the distributed estimation data.

9. The UE of claim 8, wherein the velocity estimation request includes a coarse location of the target object.

10. The UE of claim 8, wherein the velocity estimation request includes a performance error metric.

11. The UE of claim 10, wherein the performance error metric includes one or more of a velocity estimation resolution or a predicted covariance.

12. The UE of claim 10, wherein the performance error metric includes a velocity estimation accuracy value.

13. A network node for wireless communication, comprising:
a memory; and
one or more processors, coupled to the memory, configured to:
receive a velocity of a target object output by a user equipment (UE);
receive a velocity estimation request from the UE;
output the velocity estimation request to one or more anchor nodes;
receive distributed estimation data output by the one or more anchor nodes; and
output one or more of the distributed estimation data or an estimated velocity associated with the target object, the estimated velocity being based on the distributed estimation data.

14. The network node of claim 13, wherein the velocity estimation request includes a coarse location of the target object.

15. The network node of claim 13, wherein the velocity estimation request includes a performance error metric.

16. The network node of claim 13, wherein the one or more processors are further configured to transmit a configuration for a velocity distributed sensing mode.

17. The network node of claim 13, wherein the one or more processors are further configured to select the one or more anchor nodes based, at least in part, on one or more feasibility factors, each of the one or more feasibility factors being associated with one or more of the one or more anchor nodes.

18. The network node of claim 13, wherein the one or more processors are further configured to receive input information from the one or more anchor nodes.

19. The network node of claim 13, wherein the one or more processors are further configured to receive one or more of a location or mobility pattern associated with each of the anchor nodes.

20. The network node of claim 13, wherein the one or more processors are further configured to receive an availability metric associated with each of the one or more anchor nodes.

21. The network node of claim 13, wherein the one or more processors are further configured to select the one or more anchor nodes based, at least in part, on target information and input information from the one or more anchor nodes.

22. The network node of claim 13, wherein the one or more processors are further configured to configure the anchor nodes to perform a monostatic sensing operation.

23. The network node of claim 13, wherein the one or more anchor nodes include one or more static objects.

24. The network node of claim 13, wherein the one or more anchor nodes include one or more dynamic objects.

25. A method of wireless communication performed by a user equipment (UE), comprising:
estimating a velocity of a target object;
outputting a velocity estimation request; and
receiving one or more of distributed estimation data or an estimated velocity associated with the target object, the distributed estimation data being collected by one or more anchor nodes and the estimated velocity being based on the distributed estimation data.

26. The method of claim 25, wherein the velocity estimation request includes a coarse location of the target object.

27. The method of claim 25, wherein the velocity estimation request includes a performance error metric.

28. The method of claim 27, wherein the performance error metric includes a velocity estimation accuracy value.

29. The method of claim 25, further comprising receiving a configuration for a velocity distributed sensing mode.

30. The method of claim 29, further comprising transmitting a request to initiate the velocity distributed sensing mode.
